(19) United States
(12) Patent Application Publication
(10) Pub. No.: US 2015/0027136 A1
(43) Pub. Date: Jan. 29, 2015

(54) Storage and Dispensing System for a Liquid Cryogen

(71) Applicants: Robert F. Desjardins, Boston, NY (US); Brendan Neill, Akron, NY (US)

(72) Inventors: Robert F. Desjardins, Boston, NY (US); Brendan Neill, Akron, NY (US)

(73) Assignee: Green Buffalo fuel, LLC, Tonawanda, NY (US)

(21) Appl. No.: 13/948,354

(22) Filed: Jul. 23, 2013

(51) Int. Cl. F17C 7/02

(52) U.S. Cl. CPC F17C 7/02
USPC 62/50.7

(57) ABSTRACT

A two line system for storing and dispensing cryogenic liquids from a bulk storage tank to a secondary container without the use of a cryogenic pump. A first line is in communication with the vapor space of a secondary container and a compressor, the compressor being used to depressurize the secondary container to a point where the bulk storage tank is at a higher pressure than the secondary container. The first line can direct the evacuated gas either into the bulk storage tank, towards separate holding tanks, or towards any other application. A second line is in communication between the bulk storage container and the secondary container. When the compressor is activated, the pressure in the secondary container will fall below the pressure in the bulk storage tank, causing the cryogen to flow from the now higher pressure bulk storage tank into the secondary container.

### BACKGROUND OF THE INVENTION

This disclosure generally relates to the storage and delivery of cryogens. More specifically, this disclosure relates to mobile cryogenic liquid storage and dispensing system that delivers a liquid cryogen to a secondary container without using a cryogenic pump.

For the purposes of this application, cryogenic liquids are liquefied gases that boil at or below −180° F. under normal atmospheric pressure. An example of a cryogenic gas would be LNG, which boils at −260° F.

It is common for cryogenic liquids to be dispensed from either a stationary or a mobile bulk storage tank into smaller secondary containers where the cryogen is stored until it is consumed or retransferred. If a mobile bulk storage tank is used, it will often be horizontally oriented, as that aligns with conventional trailers.

Because of the low temperatures required to keep the cryogen in its liquid state, both bulk storage tanks and secondary containers are typically doubled walled vacuum insulated vessels, with the space between the two vessels containing insulating material. This is done to improve the thermal performance of the vessel by insulating the stored cryogen from the atmosphere.

While many of today's cryogenic vessels do an admirable job of keeping the cryogen insulated, it is impossible to completely insulate the storage containers, as any contact between the inner vessel and the outer vessel serves as a path for ambient heat to reach the inner vessel which will warm the cryogen. This is typically referred to as “heat leak.” Heat leak is a concern because as the cryogen heats up it will revert to its gaseous state and expand, thereby increasing the pressure in the inner vessel. Heat leak is especially a problem with portable containers, as the structure reinforcements needed to make the containers durable also serve as heat leak paths.

In order for the secondary storage containers to be filled, there must be a certain amount of differential pressure between the secondary storage containers and the cryogen entering the container. Specifically, the pressure of the incoming cryogen must be greater than that of the secondary storage container. However, due to heat leak, essential operating pressures in the secondary storage containers, or a combination of the two, in many applications the pressure in the secondary container will exceed the pressure in the bulk storage tank. This becomes an issue when the secondary container needs to be refilled. Currently available dispensing systems achieve the necessary differential pressure through several different methods.

Some systems such as the Chart HLD system, have an onboard heat exchanger which is used to increase the pressure in the bulk storage tank. Once the pressure in the bulk storage tank is adequate for filling the secondary container, the secondary container is connected to the bulk storage tank and the pressure from the bulk storage tank is used to fill the secondary container. After the secondary container is filled it is disconnected from the bulk storage tank. The bulk storage tank must then be vented to avoid over-pressurization. To do this, gas from the bulk storage tank is released to atmosphere until the internal pressure is adequate.

This dispensing method presents several problems. First, heat exchangers take time to build pressure; meaning that unless you are constantly filling secondary containers, thereby not needing to vent the bulk storage tank, it will take time to get the bulk storage tank to a sufficient operating pressure, slowing the filling process. Second, venting is an inefficient and can be an environmentally destructive process, especially if the cryogen is a greenhouse gas. By venting the gas, the operator is losing product and therefore losing potential profits. Third, many bulk storage tanks are not rated to withstand the pressures that secondary storage containers. If a secondary storage container is returned with a pressure near its maximum allowable working pressure, and that pressure exceeds the maximum allowable working pressure of bulk storage tank, you can't build enough pressure in the bulk storage tank to push it in to the secondary storage container. This necessitates venting the secondary storage container before it can be filled, which as explained above is undesirable.

Other systems utilize a low pressure bulk storage tank and an external cryogenic liquid pump or a sump containing a cryogenic liquid pump to generate sufficient pressure to fill the secondary container. Systems using an external cryogenic liquid pump will draw liquid from the bulk storage tank, pressurize it, and send it into the secondary storage container. A problem unique to having an external cryogenic liquid pump is that the pump must be cooled to cryogenic temperatures before it can be used, otherwise a portion of the cryogen will gasify before it reaches the secondary storage container. To cool the pump, the cryogen is circulated through the pump until the pump is sufficiently cooled. This cool down time increases the time needed to dispense the cryogen. In addition, the cooling of the cryogenic pump introduces a lot of heat to the bulk storage tank, as the cool-down loop typically recirculates the warmed cryogen back through the bulk storage tank which decreases stand-by or hold time for the bulk storage tank.

To overcome the shortcoming of having an external cryogenic pump, the cryogenic pump can be placed in a sump which is filled with the cryogen, thus keeping the pump at cryogenic temperatures. An issue common with all dispensing systems that use cryogenic liquid pumps, including submerged pumps, is that they all require at least an initial cool down time, when the bulk storage tank is first filled. Second liquid cryogenic pumps must be located below a low pressure bulk storage tank in order to generate enough gravitational head pressure to operate the pump, which limits the design options for a system. Third, cryogenic liquid pumps are costly to purchase and to maintain, especially if they are submerged in the cryogen because the storage tank must be opened to install or perform repairs to the pump. Fourth, cryogenic liquid pumps require a substantial amount of energy to operate, which adds to the systems overall cost. Finally, when the pump is in use, it will induce a substantial amount of heat into the bulk storage tank, which will reduce its stand-by or hold time.

Still other systems utilize a bulk storage tank, a secondary, vertically oriented sump, and a series of heat exchangers to dispense fuel. Under this system, fluid from the bulk storage tank flows into the sump. Once in the sump, a portion of the liquid is directed into a heat exchanger which is then recirculated back into the sump, which results in pressure build. The vertical orientation of the sump has the advantage of adding head pressure to the liquid, which decreases the amount of pressure that needs to be added to the sump in order to reach an adequate pressure for dispensing. The liquid in the sump is then dispensed into a secondary storage container or can be sent to a pressure builder or the bulk dispenser which can then enable dispensing straight from the bulk storage tank. An issue with this system is that by having an auxiliary sump is that the unit is less portable, especially if the auxiliary sump is vertically aligned. Second, the sump adds complexity to the system, requiring and additional interconnect between the bulk storage tank and the secondary storage containers. Finally, this system requires time to fill the sump and to build sufficient pressure for dispensing, which adds to the time needed to dispense the cryogen.

A need therefore exists for a low pressure bulk storage tank that is capable of filling a secondary storage container without the use of a cryogenic liquid pump, auxiliary storage tanks, or requiring the venting of stored gases within the secondary storage container. It is an advantage of the present disclosure that filling of the secondary storage containers from the bulk storage tank can commence immediately. It is another advantage of the present disclosure that no cryogenic pumps are utilized. It is still another advantage of the present disclosure that the bulk storage tank is in direct communication with the secondary storage container. It is still another advantage of the present disclosure that no cryogenic gases need be vented in order to fill a secondary storage container. It is still another advantage of the present disclosure that both large and small quantities of the stored cryogen can be quickly dispensed. It is still another advantage of the present disclosure that the bulk storage tank can be located below the secondary storage container when filling.

Additional objects, advantages, and novel features of the disclosure will be set forth in part in the description which follows, and in part will become apparent to those skilled in the art upon examination of the following or may be learned by practice of the disclosure. The objects and advantages of the disclosure may be realized and attained by means of the instrumentalities and combinations particularly pointed out in the appended claims.

### BRIEF SUMMARY OF THE INVENTION

The present disclosure overcomes the above-noted shortcomings and provides a new method for filling a secondary storage container with a cryogen. The mobile bulk storage tank is connected to the secondary storage container via a liquid line. A second line is connected from the vapor space of the secondary storage container to a compressor. When activated, the compressor draws the pressurized vapor from the secondary storage container, thereby dropping the pressure in the container. Once the pressure in the secondary storage container drops below the pressure in the bulk storage tank, liquid will flow from the bulk storage tank to the secondary storage container. Once the fill has been completed, the both lines are disconnected.

The vapor that has been drawn from the secondary storage container can be directed into the bulk storage tank to build pressure or directed into any other application, such as a pipeline, a gas pressurizer, etc.

### BRIEF DESCRIPTION OF THE SEVERAL VIEWS OF THE DRAWING

FIG. 1 is a simplified view of the dispensing system of the disclosure

FIG. 2 is a simplified view of the dispensing system of the disclosure where the secondary storage container outlet is located at the same point where the secondary storage container connects to a dispensing nozzle.

FIG. 3 is a simplified view of the dispensing system of the disclosure where the is an auxiliary storage tank in the gas extraction line for storing cryogenic gasses before they enter a compressor.

FIG. 4 is a simplified view of the dispensing system of the disclosure where there is no compressor.

### DETAILED DESCRIPTION OF THE PREFERRED EMBODIMENT

The following description is of the preferred embodiment and is merely explanatory in nature. In no way is the following description intended to limit the disclosure, its application, or its uses.

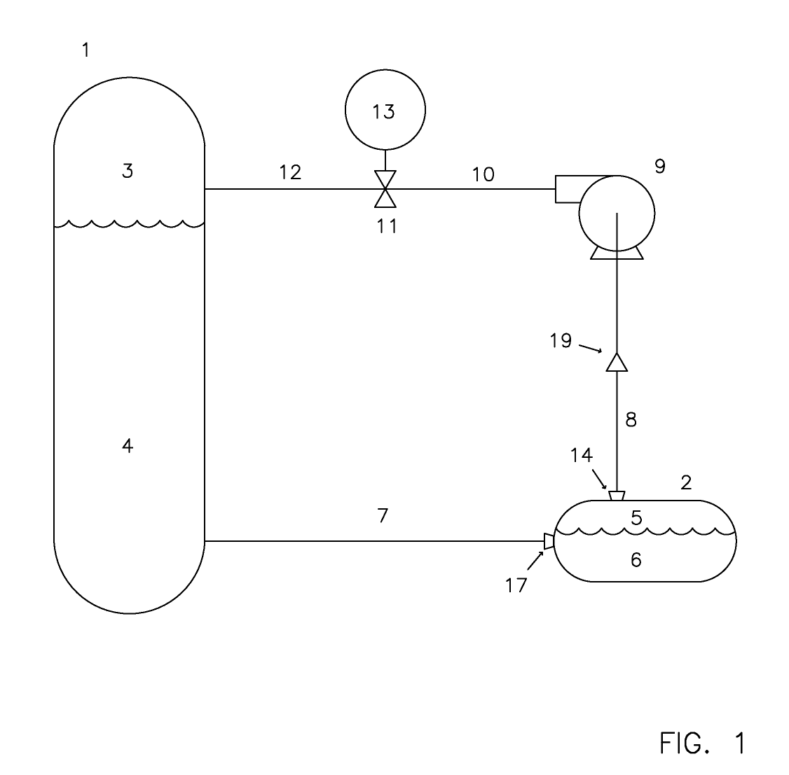

FIG. 1 shows a preferred embodiment of the cryogenic dispensing system of the disclosure. A bulk storage tank 1 is used to store a quantity of a cryogen. It may be either a fixed or a mobile bulk storage tank 1. Within the bulk storage tank 1 there is a quantity of a liquid phase of a cryogen 4 and a vapor phase of the same cryogen 3. The bulk storage tank 1 will have an initial pressure equal to that of the head pressure on the liquid cryogen 4. The pressure in the bulk storage tank 1 can be increased as needed in the method described below.

When dispensing the liquid phase of the cryogen 4, the bulk storage tank 1 is connected to a secondary storage container 2 via a fuel fill line 7, with a dispensing nozzle 17. The secondary storage container 2 may contain either just the vapor phase of the cryogen 5 or both a liquid phase of a cryogen 6 and a vapor phase of the same cryogen 5, depending on whether or not the secondary storage container 2 is completely empty or not when it is refilled.

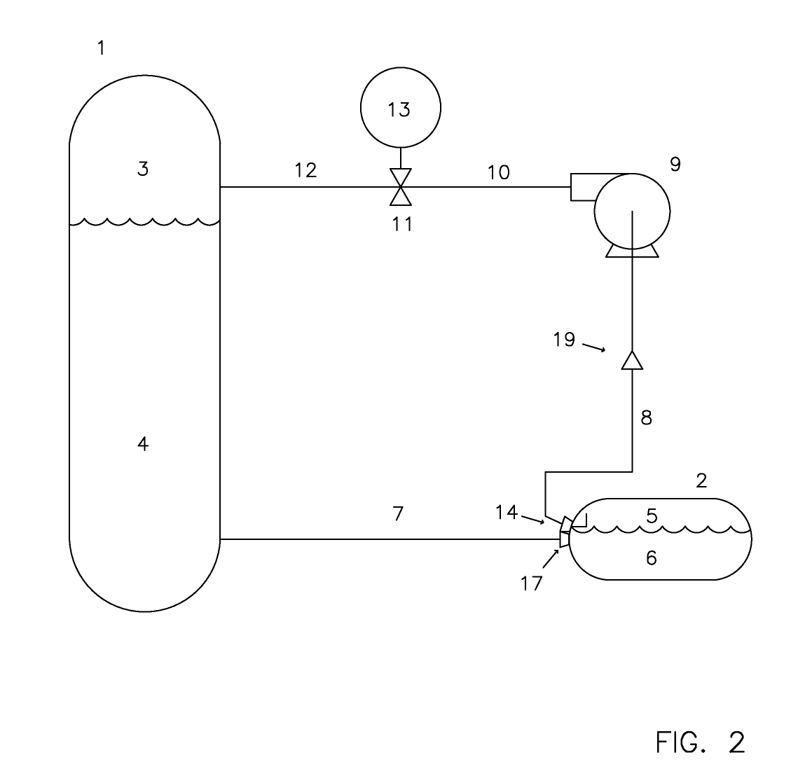

As part of the secondary storage container 2 there is an outlet 14 which is in communication with the vapor space 5 in the secondary storage container 2. The outlet 14 can be in communication with the vapor space 5 via a direct entrant into the inner vessel's vapor space 5, or it can enter the secondary storage container 2 through another point, such as at the point where the dispensing nozzle 17 is connected to the secondary storage container 2, and extends upward to the vapor space 5, as seen in FIG. 2.

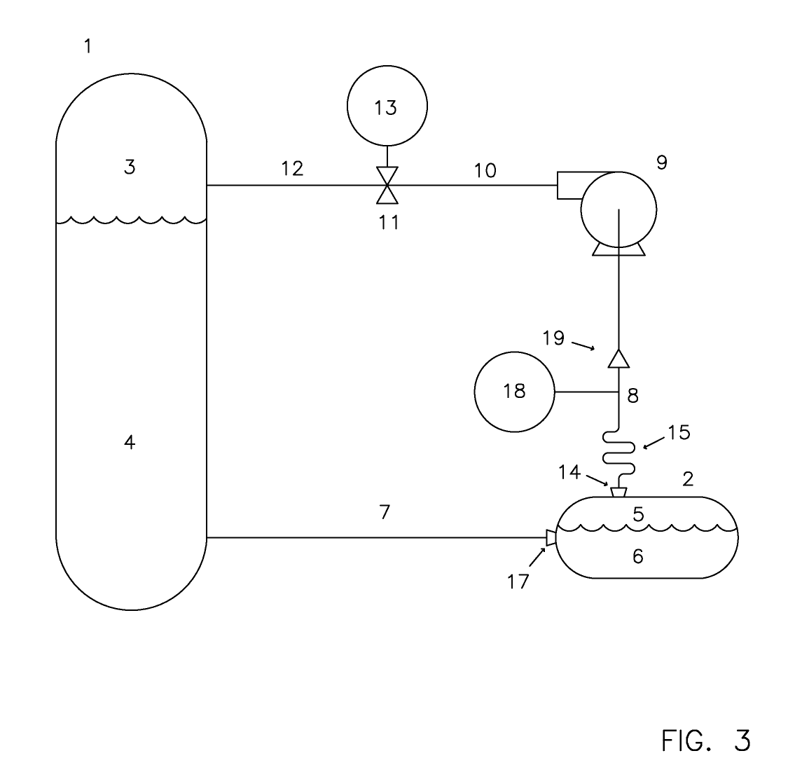

The vapor outlet 14 on the secondary storage container 2 is connected to a gas extraction line 8. The gas extraction line 8 is connected to a compressor 9. Between the vapor outlet 14 and the compressor 9 is a regulator 19 which is used to control the flow of the vapor phase of the cryogen 5 from the secondary storage container 2 to the compressor 9, so that the pressure of vapor phase of the cryogen 5 does not exceed the operating pressure of the compressor 9. As seen in FIG. 3, an auxiliary storage tank 18 may be located between the secondary storage container 2 and the regulator 19, to store the vapor phase of the cryogen 5 before it reaches the compressor 9 if the pressure of the vapor phase of the cryogen 5 exceeds the operating pressure of the compressor 9.

The compressor is connected to an outlet line 10, which contains a multi-directional valve 11. A first line 12 of the multi-directional valve 11 is connected to the vapor space 3 of the bulk storage tank 1. A second line 13 may be connected to any other application, including a liquefier, a pipeline, a compressor, etc. There may be multiple second line(s) 13 in connection with the multi-directional valve 11 as desired by the system designer.

Once the secondary storage vessel 2 has been connected to the dispensing system, the compressor 9 is activated and draws the high pressure vapor phase of the cryogen 5 from the secondary storage container 2. By removing the vapor phase of the cryogen 5 from the secondary storage container 2, the pressure in the secondary storage container 2 will drop. The compressor 9 will remain on until the pressure in the secondary storage container 2 is below that of the pressure of the liquid phase of the cryogen 4 in the bulk storage tank 1.

Once the pressure in the secondary storage container 2 is below the pressure of the bulk storage tank 1, the liquid phase of the cryogen 4 will flow from the bulk storage tank 1 to the secondary storage container 2, filling it will the liquid phase of the cryogen 6. Once the secondary storage container 2 is filled to the desired level, the compressor 9 is turned off and the dispensing nozzle 17 is disconnected from the secondary storage container.

The vapor phase of the cryogen which was removed from the secondary storage container 2 by the compressor 9 is directed to different end points via a multi-directional valve 11. The vapor phase of the cryogen may be directed into the vapor space 3 of the bulk storage tank 1, thereby increasing the pressure within the bulk storage tank 1. Alternatively, the vapor phase of the cryogen may be directed to other end points such as a liquefier, a pipeline, a pressurizer, or it may be vented to atmosphere if desired.

As illustrated in FIG. 3, the operator may desire to completely evacuate the secondary storage container 2 of all of the cryogen, both the vapor phase 5 and the liquid phase 6 before filling the secondary storage container 2. To do this, a heat exchanger 15 may be put in the outlet line 8 before the compressor 9, in order to ensure that only the vapor phase of the cryogen is entering the compressor 9. In addition, an auxiliary accumulator tank 18 may also be included in the outlet line 8 before or after the heat exchanger 15 to store the cryogen before it enters the compressor 9.

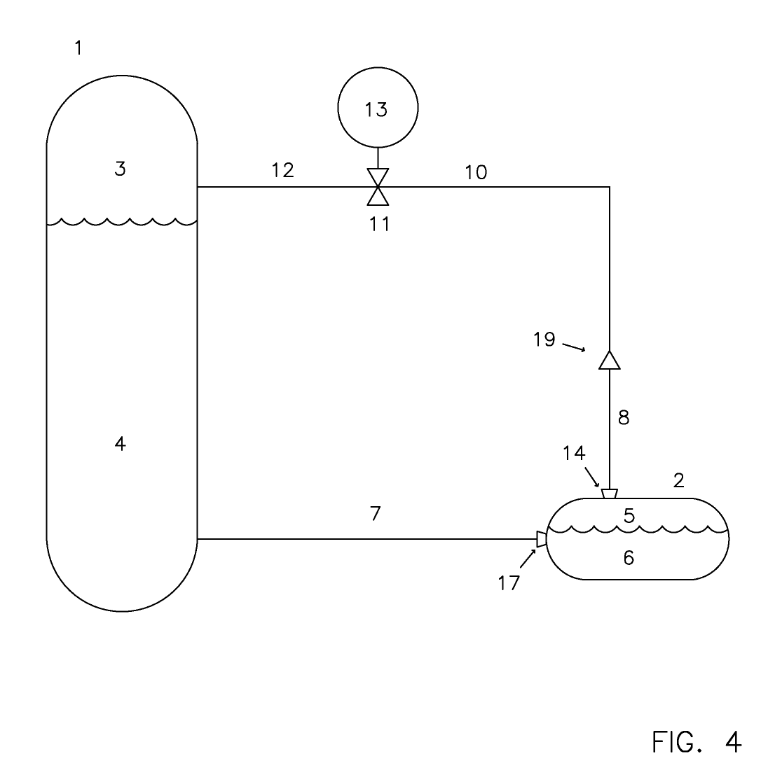

In FIG. 4, the cryogenic dispensing system does not use a compressor 9. Once the secondary storage container 2 is connected to the outlet 14, the vapor phase of the cryogen 5 will flow from the secondary storage container to where it is directed by the multi-directional valve, assuming the pressure at the location where the vapor phase of the cryogen 5 is being directed is equal to or below that of the secondary storage container 2.

In this system, if no auxiliary system 13 is at a lower pressure than the bulk storage tank 1, the cryogenic vapor 5 from the secondary storage container 2 will be directed into the bulk storage tank 1, where the pressure in the bulk storage tank 1 and the secondary storage container 2 will equalize. If the pressure in the bulk storage tank 1 and the secondary storage container 2 are equal, as long as the highest point on the secondary storage container 2 is located at a height below the lowest point of where the liquid is dispensed from the bulk storage tank 1, then liquid will flow from the bulk storage tank 1 to the secondary storage container 2, as the liquid phase of the cryogen is lighter than the vapor phase of the same cryogen.

The vapor phase of the cryogen 5 may be directed from the secondary storage container 2 to an auxiliary system 13 other than the bulk storage tank 1, if the pressure in the auxiliary system 13 will be lower than that of the bulk storage tank 1 once it is equalized with the secondary storage container 2.

If the pressure in the secondary storage container 2 is below that of the pressure in the bulk storage tank 1, when the dispensing nozzle 17 is connected and the filling is commenced, the secondary storage container 2 will be filled with the liquid cryogen 4 from the bulk storage tank 1 because of the pressure differential between the bulk storage tank 1 and the secondary storage tank 2. If the pressure in the secondary storage container 2 is below that of the bulk storage tank 1, the secondary storage container 2 does not need to be located at a point below the lowest point of where the liquid is dispensed from the bulk storage tank 1, as the secondary storage container 2 is being filled by pressure, not gravity.

As described above, the disclosed system delivers cryogenic liquid 4 from a bulk storage tank 1 to a secondary storage container 2. The disclosed system delivers a cryogenic liquid 4 without having to pressurize the said cryogenic liquid 3 using a cryogenic pump or an auxiliary sump. In addition, the bulk storage tank 1 can be kept at a low pressure throughout operation. Finally, using the disclosed system, no vapor phase of the cryogen 5 is wasted by venting it to atmosphere; rather the vapor phase of the cryogen 5 is captured and sent to either an auxiliary system 13 or to the bulk storage tank 1 where it can be redelivered to a load out facility.

What is claimed is:

1. A system for dispensing a cryogenic liquid to a secondary storage container comprising:
(a) A bulk storage tank containing a supply of a cryogenic liquid;
(b) A secondary storage container;
(c) A fuel fill line connecting said bulk storage tank to said secondary storage container;
(d) A dispensing nozzle at the end of said fuel fill fine, affixed at the end connected to the secondary storage container, to control the flow of the said cryogen to the said secondary storage container;
(e) A compressor;
(f) An outlet on said secondary storage container;
(g) A gas extraction line between the said outlet on said secondary storage container and said compressor containing a pressure regulator capable of restricting the flow of the secondary storage containers gaseous content;
(h) A multi-directional valve;
(i) An gas outlet line between said compressor and said multi-directional valve;
(j) A gas extraction line connecting the said multi-directional valve to said bulk storage tank; and
(k) A gas extraction line connecting the said multi-directional valve to a singular, or a plurality of, auxiliary systems.

2. The cryogenic dispensing system of claim 1 where the bulk storage tank is either a mobile or a stationary tank.

3. The cryogenic dispensing system of claim 1 where the dispensing nozzle at the end of said fuel fill line contains a means of controlling the flow of said cryogen into said secondary storage container.

4. The cryogenic dispensing system of claim 1 where there is a means for monitoring the flow of said cryogen into said secondary storage container

5. The cryogenic dispensing system of claim 1 where said secondary storage container has both a cryogenic liquid inlet and a gas outlet.

6. The cryogenic dispensing system of claim 4 where said cryogenic liquid inlet and said gas outlet may be located at the same point or at differing points.

7. The cryogenic dispensing system of claim 1 where said compressor, when activated, will draw the gaseous content from said secondary storage container.

8. The cryogenic dispensing system of claim 1 where either a singular or a plurality of auxiliary holding tanks may be connected to said gas extraction line between said outlet and said pressure regulator.

9. The cryogenic dispensing system of claim 7 where gas from said secondary storage container may flow to said auxiliary holding tanks where it is held before traveling to said compressor.

10. The cryogenic dispensing system of claim 1 where a heat exchanger may be in said gas extraction line between said outlet and said pressure regulator.

11. The cryogenic dispensing system of claim 1 where the gas leaving said compressor flows to said multi-directional valve and may be directed into either said bulk storage tank or to either a singular, or a plurality of, auxiliary systems.

12. A system for dispensing a cryogenic liquid to a secondary storage container comprising:
(l) A bulk storage tank containing a supply of a cryogenic liquid;
(m) A secondary storage container;
(n) A fuel fill line connecting said bulk storage tank to said secondary storage container;
(o) A dispensing nozzle at the end of said fuel fill fine, affixed at the end connected to the secondary storage container, to control the flow of the said cryogen to the said secondary storage container;
(p) An outlet on said secondary storage container;
(q) A multi-directional valve;
(r) An gas outlet line between said secondary storage container and said multi-directional valve;
(s) A pressure regulator in said gas outlet line;
(t) A gas extraction line connecting said multi-directional valve to said bulk storage tank; and
(u) A gas extraction line connecting said multi-directional valve to a singular, or a plurality of, auxiliary systems.

13. The cryogenic dispensing system of claim 12 where either a singular or a plurality of auxiliary holding tanks may be connected to said gas extraction line between said outlet and said pressure regulator.

14. The cryogenic dispensing system of claim 13 where gas from said secondary storage container may flow to said auxiliary holding tanks where it is held before traveling to said multi-directional valve.

15. The cryogenic dispensing system of claim 13 where a heat exchanger may be in said gas extraction line between said outlet and said pressure regulator.

16. The cryogenic dispensing system of claim 1 where the gas leaving said pressure regulator flows to said multi-directional valve and may be directed into either said bulk storage tank or to either a singular, or a plurality of, auxiliary systems.
